(19) United States
(12) Patent Application Publication
(10) Pub. No.: US 2008/0100172 A1
(43) Pub. Date: May 1, 2008

(54) Electric fan

(75) Inventor: Chih-Hao Yang, Tu-Cheng (TW)

Correspondence Address: PCE INDUSTRY, INC.;ATT. CHENG-JU CHIANG J, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,917

(22) Filed: Oct. 27, 2006

(51) Int. Cl. H02K 1/12; H02K 9/04

(52) U.S. Cl. 310/257; 310/216; 310/60 R

(57) ABSTRACT

An electric fan includes a stator having a bobbin (121) with coil (127) wound thereon, a first magnetic pole plate (122) arranged on a first side of the bobbin, and a second magnetic pole plate (123) arranged on a second side opposite to the first side of the bobbin. Each magnetic pole plate includes a plurality of claws (135, 145) extending substantially perpendicularly therefrom. The claws of the two magnetic pole plates are arranged in alternating fashion along a circumference of the stator. One of two neighboring claws has an ear (138, 148) extending along the circumference of the stator, and the other one of the two neighboring claws defines a cutout (136, 146) corresponding to the ear.

### CROSS-REFERENCE TO RELATED APPLICATION

This application is related to a co-pending application entitled “FERROMAGNETIC POWDER FOR DUST CORE” (Chao-Nien Tung, Chuen-Shu Hou, Chih-Hao Yang and Lung-Wei Huang) assigned to the same assignee of this application and filed on Apr. 03, 2006 with Ser. No. 11/308,530. The disclosure of the co-pending application is wholly incorporated herein by reference.

### FIELD OF THE INVENTION

The present invention relates to an electric fan, and more particularly to a motor for an electric fan.

### DESCRIPTION OF RELATED ART

With continuing development of electronic technology, electronic packages such as CPUs (central processing units) are generating more and more heat that requires immediate dissipation. Electric cooling fans are commonly used in combination with heat sinks for cooling CPUs. A rotary motor for driving an impeller of the cooling fan via magnetic torque is the currently prevailing model.

The motor generally includes a rotor and a stator. Either the rotor or the stator is a permanent magnet; the other is an electromagnet. The electromagnetic force is created by applying power to coils to generate a magnetic field, repelling the magnetic field of the permanent magnet. Thus the rotor rotates relative to the stator due to magnetic interaction between them. The impeller is attached to the rotor of the motor and moves continuously due to rotation of the rotor, thus producing a forced airflow flowing towards the CPU thus cooling the CPU. The magnetic torque between the rotor and the stator, however, must be as large as possible to drive the rotor into rotation. One solution is to enhance the output power of the motor, for example, by increasing the size or the outer diameter of the silicon steel plate of the stator or increasing the coils wound on the silicon steel plate. This will increase the size of the cooling fan, which is disadvantageous in view of the miniaturization requirements of electronic packages.

What is needed, therefore, is an electric fan having a relatively larger repellant torque and a relatively smaller size.

### SUMMARY OF THE INVENTION

According to a preferred embodiment of the present invention, an electric fan includes a bobbin with coil wound thereon, first magnetic pole plate arranged on a first side of the bobbin, and second magnetic pole plate arranged on a second side opposite to the first side of the bobbin. Each of the magnetic pole plates has a plurality of claws extending substantially perpendicularly therefrom. The claws of the first and second magnetic pole plates are arranged along a circumference of the fan in alternating fashion. One of two neighboring claws has an ear extending outwardly along the circumference of the fan, and the other one of the two neighboring claws defines a cutout corresponding in shape to the ear.

Other advantages and novel features of the present invention will be drawn from the following detailed description of a preferred embodiment of the present invention with attached drawings, in which:

### BRIEF DESCRIPTION OF THE DRAWINGS

Many aspects of the present electric fan can be better understood with reference to the following drawings. The components in the drawings are not necessarily drawn to scale, the emphasis instead being placed upon clearly illustrating the principles of the present electric fan. Moreover, in the drawings like reference numerals designate corresponding parts throughout the several views:

FIG. 1 is an isometric, explored view of an electric fan in accordance with a preferred embodiment of the present invention;

FIG. 2 is an assembled view of the electric fan of FIG. 1;

FIG. 3 is an isometric, assembled view of a stator of the electric fan of FIG. 1;

FIG. 4 is an exploded view of a bobbin of the stator;

FIG. 5 is an isometric, exploded view of a stator core of the stator; and

FIG. 6 is an isometric view of a lower magnetic pole plate of the stator core and a circuit board of the stator.

### DETAILED DESCRIPTION OF THE INVENTION

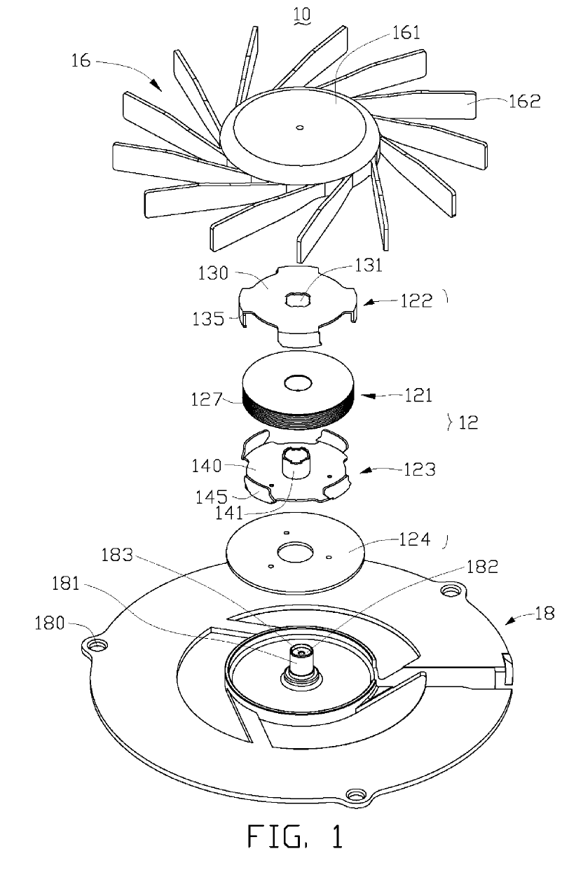

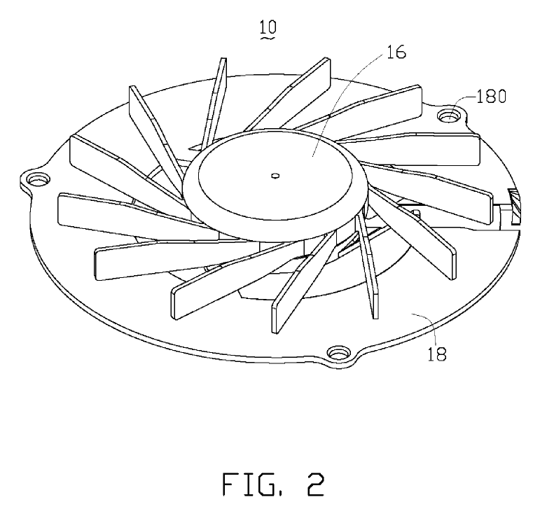

Referring to FIGS. 1-2, an electric fan 10 according to a preferred embodiment of the present invention includes a rotor 16, a stator 12 in respect to which the rotor 16 is rotatable, a frame 18 on which the rotor 16 and the stator 12 are arranged, and a bearing 182 mounted on the frame 18 for supporting rotation of the rotor 16.

The frame 18 is substantially circular. Several mounting holes 180 are defined in an outer periphery of the frame 18 for screw members (not shown) to extend therethrough to attach the electric fan 10 to a chassis of a machine (not shown). A sleeve 181 extends upwardly from a central portion of the frame 18. The sleeve 181 defines a central hole (not labeled) receiving the bearing 182 therein. An axial hole 183 is defined in the bearing 182.

The rotor 16 covers the stator 12 therein. The rotor 16 includes a hub 161, a shaft (not shown) extending downwardly from a central portion of the hub 161 to be rotatably received in the axial hole 183 of the bearing 182, a plurality of fan blades 162 extending radially from an outer-periphery of the hub 161, and a permanent magnet (not shown) adhered to an inner-periphery of the hub 161 to establish a magnetic field. Usually an annular iron shell (not shown) is arranged between the hub 161 and the permanent magnet.

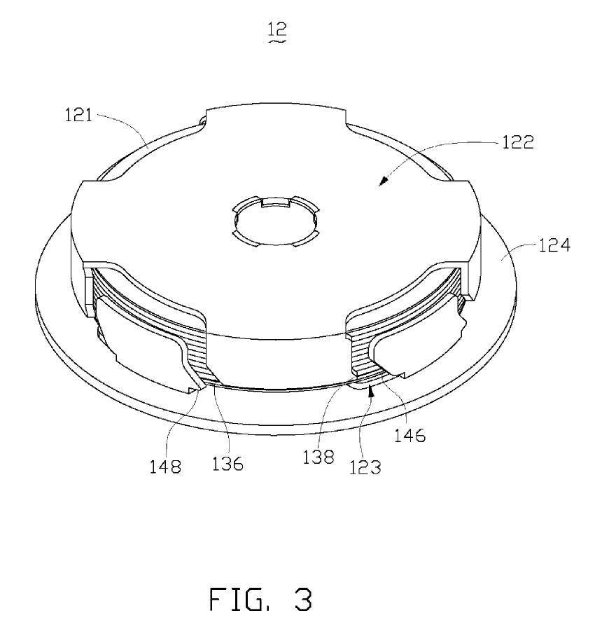

Referring to FIGS. 3-6, the stator 12 is mounted around the sleeve 181. The stator 12 includes a PCB (printed circuit board) 124, a bobbin 121 arranged on the PCB 124 with axial coil 127 wound thereon, and a stator core (not labeled) covering the bobbin 121 therein. The ends of the axial coil 127 are connected with the PCB 124 to electrically connect the coil to a power supply (not shown). The PCB 124 is ring-shaped with an opening 151 defined in a central portion thereof for extension of the sleeve 181 therethrough. Three locating holes 159 are defined in the PCB 124 around the opening 151.

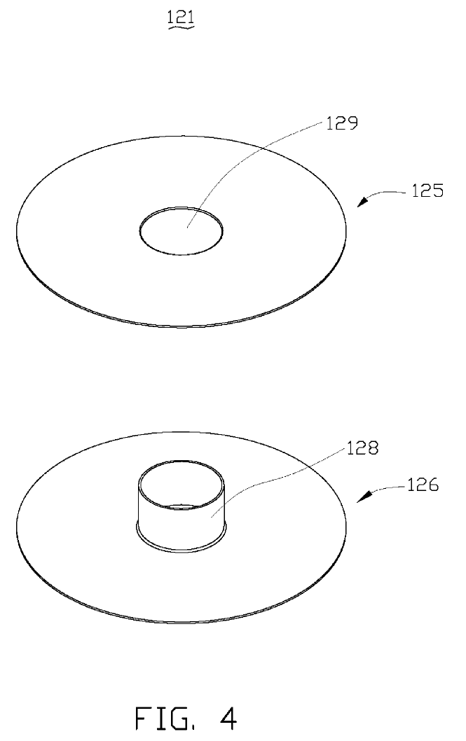

FIG. 4 shows the bobbin 121. The bobbin 121 includes an upper insulating plate 125, a lower insulating plate 126, and a cylinder 128 interconnecting the upper and lower insulating plates 125, 126. Each of the insulating plates 125, 126 is ring-shaped, defining a circular hole 129 therein. The cylinder 128 has upper and lower ends connecting to inner circumferences of the upper and lower insulating plates 125, 126, respectively. In this embodiment, the cylinder 128 is integrally formed with the lower insulating plate 126. Alternatively, the cylinder 128 can be integrally formed with the upper insulating plate 125. It is can be understood that the two insulating plates 125, 126 and the cylinder 128 can be integrally formed. The axial coil 127 winds around the cylinder 128 and is sandwiched between the two insulating plates 125, 126.

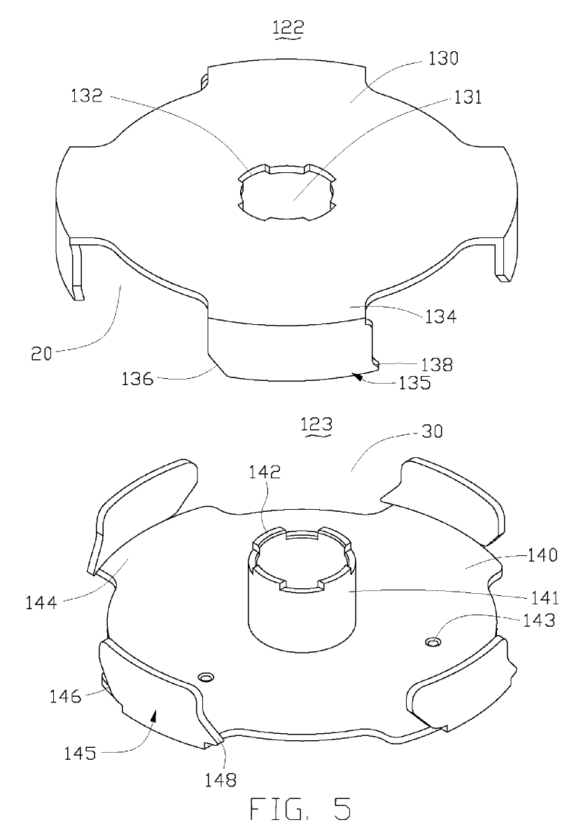

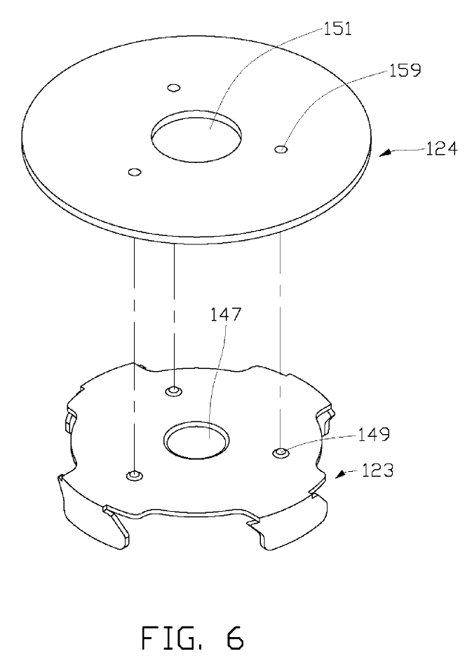

As shown in FIGS. 5-6, the stator core includes an upper and a lower magnetic pole plates 122, 123 arranged facing towards each other, and a tube 141 interconnecting the upper and lower magnetic pole plates 122, 123. Each of the magnetic pole plates 122, 123 includes a base 130, 140 and four claws 135, 145 extending therefrom. The bases 130, 140 are approximately circular and each defines a respective through hole 131, 147 therein. Four notches 132 are defined in the base 130 of the upper magnetic pole plate 122 around the through hole 131 and communicate with the through hole 131 thereof. The notches 132 are evenly spaced from each other along a circumference of the upper base 130. The tube 141 is integrally formed with and extends upwardly and perpendicularly from an inner circumference of the lower magnetic pole plate 123. Four protrusions 142 extend upwardly from a top end of the tube 141 corresponding to the four notches 132 of the upper base 130. The protrusions 142 are evenly spaced from each other along a circumference thereof. An inner diameter of the tube 141 is approximately the same as an outer diameter of the sleeve 181 for allowing extension of the sleeve 181 therethrough, and an outer diameter of the tube 141 is approximately the same as an inner diameter of the cylinder 128 of the bobbin 121. Three dome-shaped projections 149 are formed on a bottom surface of the lower base 140 corresponding to the locating holes 159 of the PCB 124. A blind hole 143 corresponding to each projection 149 is defined in a top surface of the lower base 140.

The claws 135, 145 are approximately perpendicular to their respective bases 130, 140 of the corresponding magnetic pole plates 122, 123. The bases 130, 140 each forms four necks 134, 144 interconnecting their respective bases 130, 140 and claws 135, 145. The necks 134, 144 extend radially and outwardly from an outer periphery of each base 130, 140, and are evenly spaced from each other along a circumference thereof. Each claw 135, 145 includes a tip end bending from the neck 134, 144, and a free end extending towards the base 140, 130 of the other magnetic pole plate 123, 122. A slot 20, 30 is thus defined between neighboring claws 135, 145 of each magnetic pole plate 122, 123. An upper ear 138 extends anti-clockwise along the stator 12 from a right side of the free end of each claw 135 of the upper magnetic pole plate 122. An upper cutout 136 is defined in a left side of the free end of each claw 135 of the upper magnetic pole plate 122. A lower ear 148 extends anti-clockwise from a right side of the tip end of each claw 145 of the lower magnetic pole plate 123. A lower cutout 146 is defined in a left side of the tip end of each claw 145 of the upper magnetic pole plate 122. Alternatively, the ears 138, 148 can extend clockwise along the stator 12. Each of the ears 138, 148 and cutouts 136, 146 is triangle-shaped.

During assembly, the lower magnetic pole plate 123 covers on a bottom surface of the lower insulating plate 126 of the bobbin 121, and the tube 141 extends through the cylinder 128. The upper magnetic pole plate 122 covers the upper insulating plate 125 of the bobbin 121. The protrusions 142 of the tube 141 engage into the notches 132 of the upper magnetic pole plate 122 to connect the bobbin 121 and the stator core together. The upper and lower magnetic pole plates 122, 123 intermesh with each other. The claws 135 of the upper magnetic pole plate 122 insert into the slots 30 of the lower magnetic pole plate 123, and the claws 145 of the lower magnetic pole plate 123 insert into the slots 20 of the upper magnetic pole plate 122. The upper ears 138 of the upper magnetic pole plate 122 are received in the lower cutouts 146 of the lower magnetic pole plate 123, and the lower ears 148 of the lower magnetic pole plate 123 are received in the upper cutouts 136 of the upper magnetic pole plate 122. Thus the upper and lower magnetic pole plates 122, 123 cover the bobbin 121 therein. The ends of the coil 127 wound on the cylinder 128 of the bobbin 121 connect to the PCB 124 to electrically connect the coil 127 to the power supply. Thus the stator 12 of the fan 10 is assembled. The projections 149 of the lower magnetic pole plate 123 are received in the locating holes 159 of the PCB 124 to fix the lower magnetic pole plate 123 to the PCB 124.

The sleeve 181 of the frame 18 extends through the opening 151 of the PCB 124 and the tube 141 of the lower magnetic pole plate 123 of the stator 12 to mount the stator 12 thereon. The shaft of the rotor 16 extends into the axial hole 183 of the bearing 182 which is received in the central hole of the sleeve 181. During operation, the axial coil 127 establishes an alternating magnetic field which interacts with the magnetic field of the permanent magnet of the rotor 16, thus driving the rotor 16 to rotate. Because of the ears 138, 148 formed on the claws 135, 145 of the magnetic pole plates 122, 123, the area of the magnetic pole plates 122, 123 is increased. The magnetic torque between the rotor 16 and the stator 12 is thus increased. The speed and pressure of forced airflow generated by the electric fan are increased. After leaving the fan 10, the forced airflow with increased speed and pressure blows onto the heat-generating component and takes away the heat thereof effectively. Thus the flow rate of the forced airflow and the heat dissipating effectiveness of the electric fan 10 are improved. The claws 135, 145 are asymmetrical, and therefore avoid a dead angle of the electric fan 10 and thus the electric fan 10 can be started easily and smoothly.

In the disclosed embodiment, the ears 138, 148 and cutouts 136, 146 are formed on the upper and lower magnetic pole plates 122, 123. The ears 138 and the cutouts 136 are formed on the free ends of the upper magnetic pole plate 122, and the ears 148 and the cutouts 146 are formed on the tip ends of the lower magnetic pole plate 123. It can be understood that the ears 138, 148 and the cutouts 136, 146 can instead be formed on just one of the upper magnetic pole plate 122 and the lower magnetic pole plate 123. The ears 138, 148 and the cutouts 136, 146 can be formed on the tip ends or the free ends of each magnetic pole plate 122, 123. The stator core can be made by powder sintering technology wherein powder particles for forming the stator have a core-shell structure. Such a core-shell structure of the powder can reduce the eddy current loss of the stator core. The core-shell structure of the powder has a core portion for generating magnetic force, and a shell portion for providing bonding for interconnecting the core portions of the powder together. The electrical resistance of the shell portions is greater than that of the core portions. Details regarding the Core-Shell structure of the powder for forming the stator core of the present invention can be referred to the co-pending application entitled “FERROMAGNETIC POWDER FOR DUST CORE”. In the preferred embodiments as disclosed above, the tube 141 is integrally formed with the lower magnetic pole plate 123 and then assembled to the upper magnetic pole plate 122. Alternatively, the tube 141 can be formed separately and then assembled to the upper and lower magnetic pole plates 122, 123 of the stator core. It is can be understood that the stator core can be integrally formed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stator comprising:
a bobbin with coil wound thereon;
first magnetic pole plate arranged on a first side of the bobbin, comprising a plurality of first claws extending substantially perpendicularly therefrom; and
second magnetic pole plate facing the first magnetic pole plate and being arranged on a second side opposite to the first side of the bobbin, having a plurality of second claws extending substantially perpendicularly therefrom;
wherein the first and second claws are arranged in alternating fashion along a circumference of the stator, one of two neighboring first and second claws having an ear extending along the circumference of the stator, the other one of the two neighboring claws defining a cutout corresponding in shape to the ear.

2. The stator as claimed in claim 1, wherein the ear and the cutout are triangle-shaped.

3. The stator as claimed in claim 1, wherein the ear is formed on a free end of each first claw away from the first magnetic pole plate, and the cutout is defined in a tip end of each second claw near the second magnetic pole plate.

4. The stator as claimed in claim 1, wherein the ear is formed on a tip end of each second claw near the second magnetic pole plate, and the cutout is defined in a free end of each first claw away from the first magnetic pole plate.

5. The stator as claimed in claim 1, wherein a first ear is formed at a side of each first claw, a first cutout is defined at an opposite side of each first claw, and wherein a second ear is formed at a side of each second claw corresponding to the first cutout, and a second cutout is defined at an opposite side of each second claw corresponding to the first ear.

6. The stator as claimed in claim 5, wherein the first ears are formed on free ends of the first claws away from the first magnetic pole plate, the second ears are formed on tip ends of the second claws near the second magnetic pole plate, the first cutouts are defined free ends of the first claws away from the first magnetic pole plate, and the second cutouts are defined tip ends of the second claws near the second magnetic pole plate.

7. The stator as claimed in claim 1, wherein a plurality of necks extends radially and outwardly from an outer periphery of each magnetic pole plate, the claws bending from outer peripheries of the necks.

8. The stator as claimed in claim 1, further comprising a tube interconnecting inner circumferences of the first and second magnetic pole plates, a plurality of notches being defined in one of the tube and the magnetic pole plates, a plurality of protrusions formed on the other one of the tube and the magnetic pole plates and engaging with the notches of the one of the tube and the magnetic pole plates to lock the tube to the magnetic pole plates.

9. The stator as claimed in claim 1, further comprising a printed circuit board being electrically connected with the coil, a plurality of locating holes being defined in the printed circuit board, a plurality of projections corresponding to the locating holes formed on one of the magnetic pole plates which is located near the printed circuit board.

10. An electric fan comprising:
a frame;
a stator arranged on the frame, comprising:
a printed circuit board;
a bobbin with coil wound thereon, the coil being electrically connected to the printed circuit board;
first magnetic pole plate arranged on a first side of the bobbin, comprising a plurality of first claws extending substantially perpendicularly therefrom; and
second magnetic pole plate arranged on a second side opposite to the first side of the bobbin, having a plurality of second claws extending substantially perpendicularly therefrom;
wherein the first and second claws are alternately arranged along a circumference of the stator, one of two neighboring first and second claws having an ear extending along the circumference of the stator, the other one of the two neighboring first and second claws defining a cutout corresponding to the ear; and
a rotor being rotatably supported by the stator.

11. The electric fan as claimed in claim 10, wherein a plurality of locating holes are defined in the printed circuit board, and a plurality of projections corresponding to the locating holes forms on one of the magnetic pole plates which is located near the printed circuit board.

12. The electric fan as claimed in claim 10, further comprising a tube interconnecting inner circumferences of the first and second magnetic pole plates, a plurality of notches being defined in one of the tube and the magnetic pole plates, a plurality of protrusions formed on the other one of the tube and the magnetic pole plates, and engaging with the notches of the one of the tube and the magnetic pole plates to lock the tube with the magnetic pole plates.

13. The electric fan as claimed in claim 10, wherein a first ear forms at a side of each first claw, a first cutout is defined at an opposite side of each first claw; a second ear is formed at a side of each second claw corresponding to the first cutout, and a second cutout is defined at an opposite side of each second claw corresponding to the first ear.

14. The electric fan as claimed in claim 13, wherein the first ears form on free ends of the first claws away from the first magnetic pole plate, the second ears form on tip ends of the second claws near the second magnetic pole plate, the first cutouts are defined free ends of the first claws away from the first magnetic pole plate, and the second cutouts are defined tip ends of the second claws near the second magnetic pole plate.
